(19) United States
(12) Patent Application Publication
(10) Pub. No.: US 2021/0298378 A1
(43) Pub. Date: Sep. 30, 2021

(54) ELASTIC, NONWOVEN FACE COVERINGS AND PACKAGES CONTAINING FACE COVERINGS

(71) Applicant: DUKANE IAS, LLC, St. Charles, IL (US)

(72) Inventors: Dan Wallander, Neenah, WI (US); Melissa Offenstein, Neenah, WI (US); Terry Kaminski, Neenah, WI (US); Patrick Sean McNichols, Hortonville, WI (US); Daniel James Sorensen, Neenah, WI (US); Thomas David Ehlert, Neenah, WI (US); Gregory Robert Benrud, Neenah, WI (US)

(21) Appl. No.: 17/092,131

(22) Filed: Nov. 6, 2020

Related U.S. Application Data
(60) Provisional application No. 62/705,289, filed on Jun. 19, 2020.
(60) Provisional application No. 63/000,795, filed on Mar. 27, 2020.

(51) Int. Cl. A41D 13/11; A41D 31/02; B65D 83/08; B65D 85/18

(52) U.S. Cl. CPC A41D 13/1115; A41D 31/02; B65D 83/0805; B65D 2583/082; A41D 2300/50; A41D 2500/30; B65D 85/18

(57) ABSTRACT

A face covering includes layers of nonwoven material and at least one elastic element. The layers of nonwoven material cooperatively define a first opening, a second opening, and a filtration area of the face covering. The filtration area is arranged to allow airflow through the face covering and remove particulates from the airflow. The first opening and the second opening are sized to receive a head of a wearer. The at least one elastic element is secured to the layers of nonwoven material. The face covering is sized such that, when the face covering is positioned on the head of the wearer, the at least one elastic element provides a seal against the wearer and the layers of nonwoven material provide a loose fit on the wearer.

### CROSS-REFERENCE TO RELATED APPLICATIONS

This application claims priority to U.S. Provisional Application No. 62/705,289 filed Jun. 19, 2020, and U.S. Provisional Application No. 63/000,795 filed Mar. 27, 2020, which are hereby incorporated by reference in their entirety.

### FIELD

Recently, people have grown increasingly concerned with the transmission of viruses and other contaminates through social interaction. For example, the novel coronavirus discovered in 2019 (COVID 19) is believed to be spread at least partly between people interacting in close proximity and has led to a worldwide pandemic. According to the Center for Disease Control and Prevention (CDC), a significant portion of individuals with coronavirus lack symptoms (“asymptomatic”) and even those who eventually develop symptoms (“pre-symptomatic”) can transmit the virus to others before showing symptoms. In addition, the virus can spread between people interacting in close proximity, for example, speaking, coughing, or sneezing, even if those people are not exhibiting symptoms or touching each other.

Widespread use of face masks or face coverings in social settings could potentially reduce the transmission of coronavirus and other viruses. However, some people may not be able to obtain face masks to wear every day. For example, people may not be able to purchase face masks because the face masks may be expensive, reserved for individuals in medical or other fields, or otherwise unavailable. Accordingly, some people have resorted to using home-made face masks. However, home-made face masks are not typically tested for efficacy and are not subject to quality regulations. Thus, the home-made face masks may not provide the best protection against the transmission of viruses. In addition, the face masks, whether purchased or home-made, must be worn properly to be effective in reducing the transmission of viruses. However, many people may not know how to wear their face masks properly and/or may have difficulty in donning the face masks properly.

Due to the potential risk of transmission by asymptomatic and pre-symptomatic people, people may attempt to avoid situations in which they could be exposed to or expose others to viruses, such as visiting or working at businesses in which employees and/or customers may interact in close proximity. Accordingly, some employers may provide face coverings for their employees and/or their customers. For example, in the healthcare industry, employers may provide face coverings as personal protective equipment (PPE) for employees who are regularly exposed to viruses. In addition, retail stores and restaurants may provide face coverings for customers and/or employees to make the customers and employees more comfortable in the stores and reduce the possibility of transmission of viruses between customers and employees. However, the face coverings may be expensive and difficult for the employers to purchase, store, and distribute.

Elastic nonwoven materials are utilized in a variety of articles including personal care articles (e.g., adult briefs, baby diapers, child/adult pull-on pants, contour fit hygiene products, etc.) and medical garments (e.g., masks, caps, gowns, footwear, etc.). The elastic nonwoven materials may be used to produce articles that are less expensive than cloth products and can be disposed of after use. Accordingly, elastic nonwoven materials may provide a solution to enable increased production of face masks and increase the availability of face masks. However, current elastic nonwoven face masks are designed similar to cloth face masks and suffer from some of the same problems as cloth face masks. For example, the nonwoven face masks may be difficult for a user to put on and wear properly and are not completely effective in preventing the transmission of viruses.

Accordingly, there is a need for cost effective methods and systems to produce face masks and face coverings that are simple to put on and effective in reducing the transmission of viruses. There is also a need for suitable packaging for such face coverings.

### SUMMARY

In one embodiment, a face covering generally comprises a first layer of nonwoven material, a second layer of nonwoven material, a first elastic element, and a second elastic element. The first layer of nonwoven material and the second layer of nonwoven material cooperatively define a first opening, a second opening, and a filtration area of the face covering. The filtration area is arranged to allow airflow through the face covering and remove particulates from the airflow. The first opening and the second opening are sized to receive a head of a wearer. The first elastic element and the second elastic element are secured to the first and second layers. The face covering is sized such that, when the face covering is positioned on the head of the wearer, the first and second elastic elements provide a seal against the wearer and the first and second layers provide a loose fit on the wearer. A ratio of a perimeter of the face covering to the filtration area is equal to or less than 0.35.

In another embodiment, a face covering generally comprises layers of nonwoven material, a first elastic element, and a second elastic element. The layers of nonwoven material cooperatively define a first opening and a second opening and form a sleeve that extends continuously between the first opening and the second opening. The first and second openings each are circular and have a circumference. The first elastic element is secured to the layers of nonwoven material and circumscribes the first opening such that the circumference of the first opening is less than a circumference of the sleeve between the first and second openings when the face covering is in a relaxed state. The second elastic element is secured to the layers of nonwoven material and circumscribes the second opening such that the circumference of the second opening is less than the circumference of the sleeve between the first and second openings when the face covering is in the relaxed state. The face covering is sized such that, when the face covering is positioned on the head of the wearer, the first and second elastic elements provide a seal against the wearer and the layers of nonwoven material provide a loose fit on the wearer.

In yet another embodiment, a package of nonwoven face coverings generally comprises face coverings and a container to hold the face coverings. The face coverings each include at least one nonwoven layer and at least one elastic element. Each face covering is sized such that the at least one elastic element provides a seal against a wearer and the nonwoven layer provides a loose fit on the wearer. The face coverings are produced in a continuous form using a continuous manufacturing method and are connected to each other. The container includes an opening for dispensing the face coverings and is configured to separate a single face covering from the other face coverings when a person removes the single face covering from the container through the opening.

### BRIEF DESCRIPTION OF THE DRAWINGS

FIG. 1 is a schematic illustration of a system for fabricating an elastic nonwoven material;

FIG. 2 is a perspective view of one suitable embodiment of a rotary ultrasonic bonding apparatus for use in the system of FIG. 1;

FIG. 3 is a schematic illustration of a system for fabricating a face covering using an elastic nonwoven material;

FIG. 4 is a perspective view of a roll of face coverings that may be produced using the system of FIG. 3;

FIG. 5 is a perspective view of a folded arrangement of face coverings that may be produced using the system of FIG. 3;

FIG. 6 is a perspective view of a face covering that may be produced using the system of FIG. 3;

FIG. 7 is a laid flat side view of the face covering of FIG. 6;

FIG. 8 is a perspective view of a person wearing the face covering of FIG. 6, the face covering providing a loose fit of on the wearer;

FIG. 9 is a perspective view of another person wearing the face covering of FIG. 6, the person wearing glasses over the face covering;

FIG. 10 is a perspective view of the person wearing the face covering of FIG. 6, and illustrating the face covering protecting the ears of the wearer;

FIG. 11 is a perspective view of the person wearing the face covering of FIG. 6, and illustrating the face covering sealing against the neck of the wearer;

FIG. 12 is a perspective view of the person wearing the face covering of FIG. 6, the person wearing the face covering with an upper edge of the face covering positioned under their ears;

FIG. 13 is a perspective view of yet another person donning the face covering of FIG. 6;

FIG. 14 is a perspective view of a first step of a person removing the face covering of FIG. 6;

FIG. 15 is a perspective view of a second step of the person removing the face covering of FIG. 6;

FIG. 16 is a laid flat view of an embodiment of a face covering that may be produced using the system of FIG. 3, the face covering including ear openings;

FIG. 17 is a laid flat view of an embodiment of a face covering that may be produced using the system of FIG. 3, the face covering including ties;

FIG. 18 is a laid flat view of an embodiment of a face covering that may be produced using the system of FIG. 3, the face covering having a triangular shape;

FIG. 19 is a laid flat view of an embodiment of a face covering that may be produced using the system of FIG. 3, the face covering including a nose piece;

FIG. 20 is a front perspective view of a person wearing a face covering that may be produced using the system of FIG. 3, the face covering having a tight fit on the wearer;

FIG. 21 is a side perspective view of the person wearing the face covering of FIG. 20;

FIG. 22 is a perspective view of a package including a roll of face coverings and a container for dispensing the face coverings;

FIG. 23 is a perspective view of a package including a stack of face coverings and a container for dispensing the face coverings;

FIG. 24 is a top view of the package of FIG. 23, and illustrating a face covering being dispensed from the container; and

FIG. 25 is a laid flat view of a prior art face mask.

Corresponding reference characters indicate corresponding parts throughout the several views of the drawings.

### DETAILED DESCRIPTION

Embodiments of the systems and methods described herein provide face coverings including nonwoven materials and elasticized portions. The elastic nonwoven face coverings may provide a breathable barrier around the face and nose of a wearer and catch respiratory droplets discharged when the wearer speaks, coughs, sneezes and exhales. Accordingly, the elastic nonwoven face coverings may reduce the transmission of viruses between people who are socially interacting. Moreover, the face coverings may be simpler for the wearers to don and wear properly than conventional face masks or coverings. In addition, embodiments of the face coverings described herein may be less expensive to manufacture than conventional face masks or coverings and may provide similar or increased efficiency in removing viruses expelled by the wearer.

The face coverings described herein may be produced using continuous manufacturing processes. The face coverings may be produced in continuous rolls, folded arrangements, or unfolded piles. Accordingly, the face coverings may be packaged in a manner that enables the face coverings to be dispensed quickly. For example, the face coverings may be attached to each other by detachable seams and constructed for a person to detach a single face covering from other face coverings without touching the other face coverings. Moreover, the face coverings may be stored in smaller areas than other face coverings that are not produced using a continuous manufacturing process.

The present disclosure relates to a method of producing face coverings including an elasticized portion. For example, the elasticized portion may include one or more elasticized edges of the face coverings. The elasticized portions may be constructed using any suitable processes. For example, some embodiments include methods using an elastic entrapment process and apparatus and face coverings produced using such processes and apparatus. Suitable elastic entrapment process and apparatus are described in U.S. patent application Ser. No. 14/951,884 (now U.S. Pat. No. 10,259,165); Ser. No. 15/718,872; 16/287,443 (now U.S. Pat. No. 10,479,025); Ser. No. 16/600,045; and Ser. No. 16/825,579. Each of these U.S. patent applications is incorporated herein by reference in their entirety.

It is understood that that the elasticity of each of the elastic strands of each of these face coverings can be selectively controlled (e.g., captured or deadened or cut) as described in the above-referenced patent applications. As a result, the elasticity of each elastic strand of a face covering can be selectively controlled to obtain the desired elastic profile of the face covering.

In some embodiments, the face coverings may be produced using a continuous process. For example, the face coverings may be produced using one or more manufacturing lines that receive supply of the implement products and produce a continual stream of face coverings. The face coverings may be connected or unconnected to each other. In some embodiments, the final face coverings are connected to each other in a roll or sheet. In other embodiments, the face coverings may be separated from each other during the manufacturing process. As a result, the face coverings may be less expensive and require less time to produce than face coverings that are produced individually.

It is contemplated that various types of face coverings can be produced using processes and apparatus, such as the processes and apparatus described herein and in the above-referenced patent applications. In one suitable example, the face covering is a N95 mask. N95 masks are 95% efficient at removing particulates from the air expelled by the wearer.

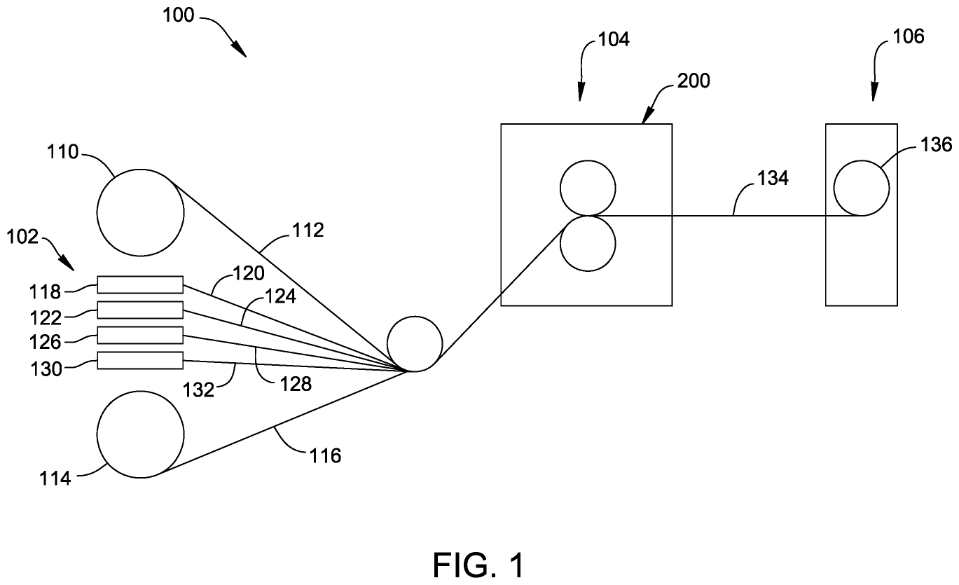

Referring to the drawings, and in particular to FIG. 1, a system for fabricating an elastic nonwoven material is indicated generally by 100. The illustrated system 100 includes a supply station indicated generally by 102, a processing station indicated generally by 104, and a collection station indicated generally by 106. Other suitable stations are also contemplated without departing from the scope of this disclosure.

In the illustrated embodiment, the supply station 102 includes a plurality of supply rolls each containing a nonwoven fabric, namely a first supply roll 110 containing a first nonwoven fabric 112 and a second supply roll 114 containing a second nonwoven fabric 116. Examples of suitable nonwoven fabrics include airlaid nonwoven webs, spunbond nonwoven webs, meltblown nonwoven webs, bonded-carded webs, hydroentangled nonwoven webs, spunlace webs or the like, as well as combinations thereof. In one suitable embodiment, for example, both of the nonwoven fabrics 112, 116 are Spunbond Meltblown Spunbond {“SMS”). SMS is a tri-laminate nonwoven fabric including a top layer of spunbond polypropylene, a middle layer of meltblown polypropylene and a bottom layer of spunbond polypropylene. It is contemplated that the nonwoven fabrics 112, 116 can, in some embodiments, include more layers of spunbond polypropylene and/or meltblown polypropylene such as Spunbond Meltblown Meltblown Spunbond (SMMS), Spunbond Meltblown Meltblown Meltblown Spunbond (SMMMS), and Spunbond Spunbond Meltblown Meltblown Spunbond (SSMMS).

The supply station 102 also includes a plurality of supply spools each containing an elastic strand, namely a first supply spool 118 containing a first elastic strand 120, a second supply spool 122 containing a second elastic strand 124, a third supply spool 126 containing a third elastic strand 128, and a fourth supply spool 130 containing a fourth elastic strand 132. The elastic strands 120, 124, 128, 132 may have any suitable cross-sectional shape that facilitates enabling the elastic strands 120, 124, 128, 132 to function as described herein (e.g., a cross-sectional shape that is round, rectangular (e.g., relatively flat), square, etc.). It is contemplated that the supply station 102 can have more or fewer supply spools. It is also contemplated that each supply spool could be adapted to feed more than one elastic strand or other suitable elastic material (e.g., an elastic laminate).

As illustrated in the exemplary embodiment, the processing station 104 includes a rotary ultrasonic bonding apparatus (indicated generally by 200) for bonding the elastic strands 120, 124, 128, 132 between the nonwoven fabrics 112, 116 to make an elastic nonwoven material 134, as set forth in more detail below. The collection station 106 may include any suitable device(s) for collecting the elastic nonwoven material 134 (e.g., a puller roll 136). In other embodiments, the supply station 102 may have any suitable quantity of supply rolls and supply spools having any suitable configuration that facilitates enabling the apparatus 200 to function as described herein.

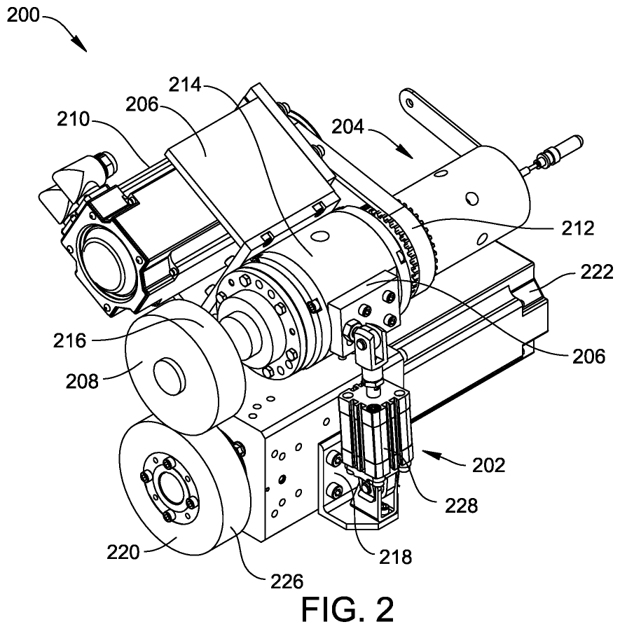

FIG. 2 illustrates one suitable embodiment of the rotary ultrasonic bonding apparatus 200. In the illustrated embodiments, the apparatus 200 has bonding modules, e.g., an anvil module 202 and a horn module 204, that cooperate to perform a bonding operation of the elastic strands 120, 124, 128, 132 between the nonwoven fabrics 112, 116 as set forth in more detail below.

In the illustrated embodiments, the horn module 204 includes a frame 206 on which are mounted a disc-like rotary horn 208, a motor 210 for driving rotation of the horn 208 via a suitable drive train 212, and a housing 214 which contains at least part of a vibration control unit (not shown) that causes the horn 208 to vibrate. The horn 208 has a face 216 with a substantially continuous contour (i.e., the horn face 216 has a contour that is substantially smooth (or uninterrupted) across its entire surface area). In other embodiments, the horn face 216 may have any suitable contour that facilitates enabling the horn 208 to function as described herein.

In some embodiments, the vibration control unit (while not illustrated) includes at least one booster (e.g., a drive booster and an integral booster) mechanically connected to a converter, which is electrically connectable to a generator. The converter is capable of converting high frequency electrical energy supplied by the generator into mechanical energy (or vibration) that is selectively transmitted to the horn 208 across the booster(s). The booster(s) are capable of modifying (i.e., increasing or decreasing) the vibration transmitted to the horn 208 from the converter, such that the horn 208 (particularly, the face 216 of the horn 208) vibrates while it rotates during a bonding operation, as set forth in more detail below. It is contemplated that the horn module 204 may have any suitable operational components arranged in any suitable manner that facilitates enabling the horn 208 to function as described herein.

In the illustrated embodiments, the anvil module 202 includes a frame 218 on which are mounted a disc-like rotary anvil 220 and a motor 222 for driving rotation of the anvil 220 via a suitable drive train. The anvil 220 has an annular face 226, the contour of which is not continuous (i.e., is interrupted). The anvil module 202 is positioned relative to the horn module 204 such that the anvil face 226 is rotatable in close proximity to the horn face 216, and vice versa, to facilitate ultrasonically bonding the elastic strands 120, 124, 128, 132 between the nonwoven fabrics 112, 116 when the elastic strands 120, 124, 128, 132 are held in tension across the apparatus 200. As used herein, the term “close proximity” refers to when the anvil face 226 is either in contact with, or is minimally spaced apart from, the horn face 216 when the horn 208 is not ultrasonically vibrating.

In some embodiments, the apparatus 200 may be configured such that at least one of the anvil module 202 and the horn module 204 is displaceable relative to the other via a suitable displacement mechanism operable either: (A) when the system 100 is offline and the horn 208 is at rest (i.e., when the horn 208 is not rotating or vibrating); or (B) when the system 100 is online and the horn 208 is active (i.e., when the horn 208 is rotating and vibrating).

As seen in the embodiment of FIG. 2, the apparatus 200 may be configured as a continuous-nip apparatus in which the horn module 204 is to be: (A) fixed in position relative to the anvil module 202 when the system 100 is online and the horn 208 is active; and (B) displaceable relative to the anvil module 202 when the system 100 is offline and the horn 208 is at rest. Such displacement is facilitated by a selectively actuatable pneumatic cylinder 228 (or other suitable linear actuator) that connects the frames 206, 218 to one another. In this manner, the spacing between the horn face 216 and the anvil face 226 is adjustable primarily for servicing the apparatus 200 when the system 100 is offline.

Notably, the apparatus 200 may have any suitable quantity of anvil modules 202 and/or horn modules 204 that cooperate with one another to facilitate enabling the apparatus 200 to function as described herein. For example, in some embodiments, the apparatus 200 may be configured with an anvil drum in which a pair of anvils 220 are positioned such that the drum has a pair of predefined, annular faces 226 that are spaced apart from one another. In this manner, the horn 208 of a separate horn module 204 is dedicated to each such anvil face 226, thereby facilitating a bonding operation on confined regions of larger nonwoven fabrics on which only partial elasticity is desired (e.g., segments of these larger nonwoven fabrics on which elasticity is not desired may move along non-contact regions of the drum to avoid interaction with the associated horn(s) 208).

To facilitate minimizing the occurrence of the elastic strands 120, 124, 128, 132 being cut between the horn 208 and the anvil 220 during a bonding operation, it is desirable to effectively hold the elastic strands in place within notches of the anvil face 226 while the nonwoven fabrics 112, 116 are bonded together between the horn and the anvil. At least the following operational parameters contribute to minimizing the occurrence of elastic strands 120, 124, 128, 132 being cut during a bonding operation: (A) the specific energy source (e.g., the amplitude of vibration of the horn 208 and its pressure when contacting the anvil 220); (B) the energy director (e.g., the geometry of the anvil face 226); and (C) the material system (e.g., the decitex and tension of the elastic strands, and the basis weight of the nonwoven fabrics 112, 116).

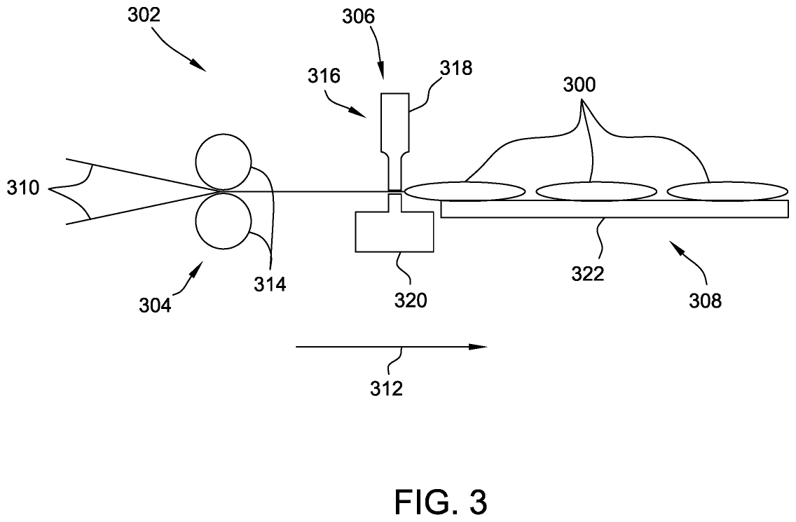

Referring to FIG. 3, a system for fabricating face coverings 300 is indicated generally by 302. The illustrated system 302 includes a supply station indicated generally by 304, a processing station indicated generally by 306, and a collection station indicated generally by 308. Other suitable stations, such as a packaging station, are also contemplated without departing from the scope of this disclosure.

In the illustrated embodiment, the supply station 304 includes a plurality of elastic nonwoven webs 310. For example, the elastic nonwoven webs 310 may be manufactured from nonwoven fabrics 112, 116 (shown in FIG. 1) and elastic strands 120, 124, 128, 132 (shown in FIG. 1) using the system 100 of FIG. 1. The elastic nonwoven webs 310 may include a plurality of interconnected elastic nonwoven sheets. The elastic nonwoven webs 310 may be provided in a roll and unwound at the supply station 304 to feed the processing station 306.

Examples of suitable nonwoven fabrics for use in the face covering 300 include airlaid nonwoven webs, spunbond nonwoven webs, meltblown nonwoven webs, bonded-carded webs, hydroentangled nonwoven webs, spunlace webs or the like, as well as combinations thereof. Other examples of suitable materials for constructing the face covering 300, in whole or in part, include rayon, bonded-carded webs of polyester, polypropylene, polyethylene, nylon, or other heat-bondable fibers, finely perforated film webs, net-like materials, and the like, as well as combinations thereof. These webs can be prepared from polymeric materials such as, for example, polyolefins, such as polypropylene and polyethylene and copolymers thereof, polyesters in general including aliphatic esters such as polylactic acid, nylon or any other heat-bondable materials. Other examples of suitable materials for the face covering 300 are composite materials of a polymer and a nonwoven fabric material. The composite materials are typically in the form of integral sheets generally formed by the extrusion of a polymer onto a nonwoven web, such as a spunbond material.

As mentioned above, the nonwoven fabrics 112, 116 and thus, the face covering 300 can be manufactured from Spunbond Meltblown Spunbond {“SMS”). SMS is a tri-laminate nonwoven fabric including a top layer of spunbond polypropylene, a middle layer of meltblown polypropylene and a bottom layer of spunbond polypropylene. It is contemplated that the face covering 300 can, in some embodiments, include more layers of spunbond polypropylene and/or meltblown polypropylene such as SMMS, SMMMS, and SSMMS.

The elastic nonwoven webs 310 are moved in a machine direction, indicated by arrow 312, from the supply station 304 to the processing station 306. Any suitable apparatus may be used to feed the webs in the machine direction 312 including, for example and without limitation, nip rolls, tensioning rolls, and combinations thereof.

In this illustrated embodiment, the processing station 306 includes nip rolls 314 and an ultrasonic bonding apparatus generally indicated by 316. The ultrasonic bonding apparatus 316 includes an ultrasonic horn 318 and an anvil 320. The ultrasonic bonding apparatus 316 is configured to receive the elastic nonwoven webs 310 between the ultrasonic horn 318 and the anvil 320 and bond the elastic nonwoven webs together. For example, the ultrasonic horn 318 may vibrate at an ultrasonic frequency relative to the anvil 320 and ultrasonically bond selected portions of the elastic nonwoven webs 310. In addition, the ultrasonic bonding apparatus 316 may be configured to at least partially cut the elastic nonwoven webs 310 at selected areas in the elastic nonwoven webs. Suitably, the ultrasonic bonding apparatus 316 is configured to cut each of the elastic nonwoven webs 310 in a cross-machine direction and bond the webs together along the cuts to form the face coverings 300. Each face covering 300 is formed from two superposed sections of the webs 310 that are bonded together at seams extending along the cut edges to form a ring or sleeve.

In other suitable embodiments, the processing station 306 may include any suitable apparatus to form the face coverings 300 including, for example and without limitation, adhesive applicators, compression rolls, nip rolls, laminator rolls, chill rolls, ultrasonic horns, anvils, and combinations thereof. In such embodiments, the webs 310 may be joined together by any suitable means including, for example and without limitation, adhesive bonds, ultrasonic bonds, thermal bonds, pressure bonds, and combinations thereof.

The collection station 106 may include any suitable device(s) for collecting the elastic nonwoven material 134. For example, the collection station 308 may include a conveyor 322 for transporting the face coverings 300. In addition, the collection station 308 may include an apparatus that arranges interconnected face coverings 300 into a roll, folded stack, or unfolded pile.

During operation of the system 302, the elastic nonwoven webs 310 are moved from the supply station 304 to the processing station 306 and received by the nip rolls 314 at the processing station. The elastic nonwoven webs 310 are moved in the machine direction 312 such that the elastic strands extend in the machine direction. For example, the elastic nonwoven webs 310 are positioned in close contact and in superposed position with each other for feeding into the ultrasonic bonding apparatus 316. At the ultrasonic bonding apparatus 316, the elastic nonwoven webs 310 are bonded together to form the face coverings 300.

In the illustrated embodiment, bonding and cutting operations may be performed at a single station (i.e., the processing station 306). In other suitable embodiments, the bonding and cutting operations may be carried out at separate stations, such as a dedicated bonding station and a dedicated cutting station. It is contemplated that the bonding and cutting operations can occur at various locations during the manufacture process. In one suitable embodiment, the cutting operation and thus the cutting station is located adjacent the collection station 308.

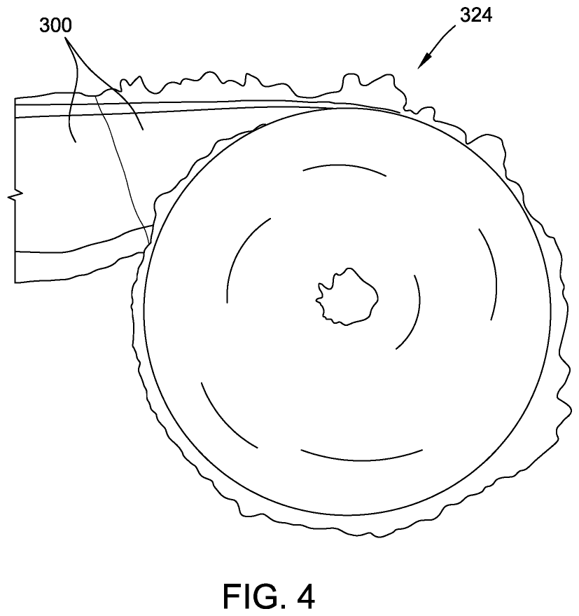

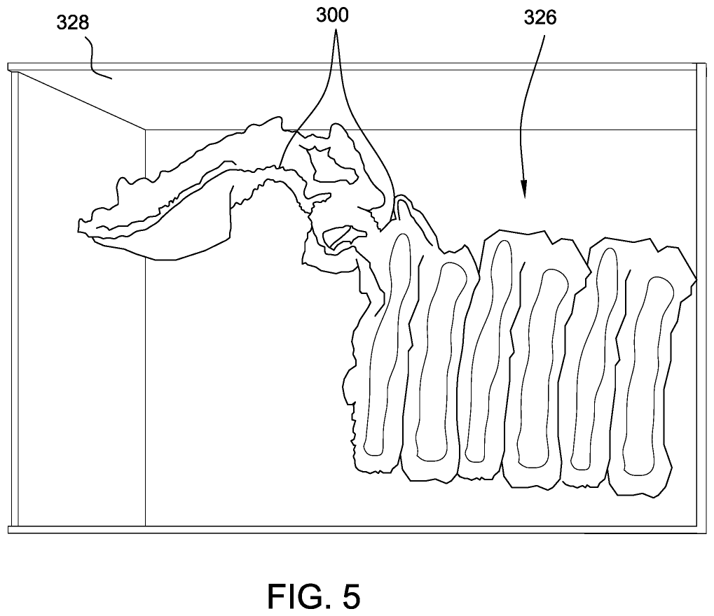

The face coverings 300 are collected at the collection station 308. For example, the face coverings 300 may be wound in a roll such as roll 324 in FIG. 4, folded into a folded arrangement such as stack 326 in FIG. 5, or placed in unfolded arrangements at the collection station 308. The face coverings 300 may be packaged for shipping at the collection station 308 or at a subsequent station. For example, the collected face coverings 300 may be placed in a container such as container 328 shown in FIG. 5.

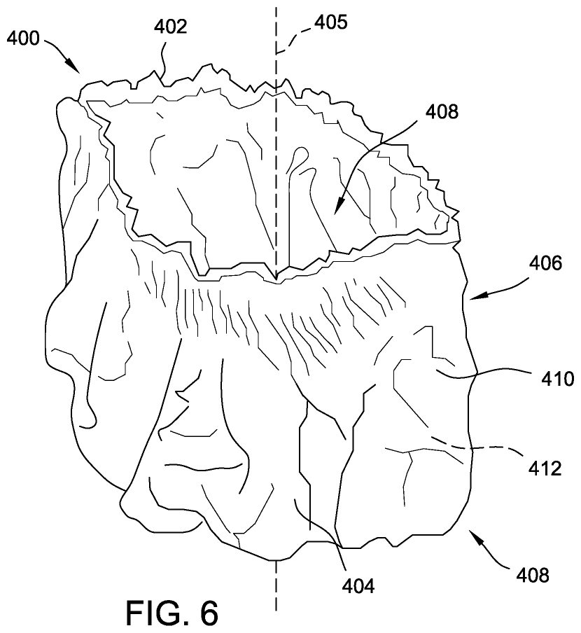

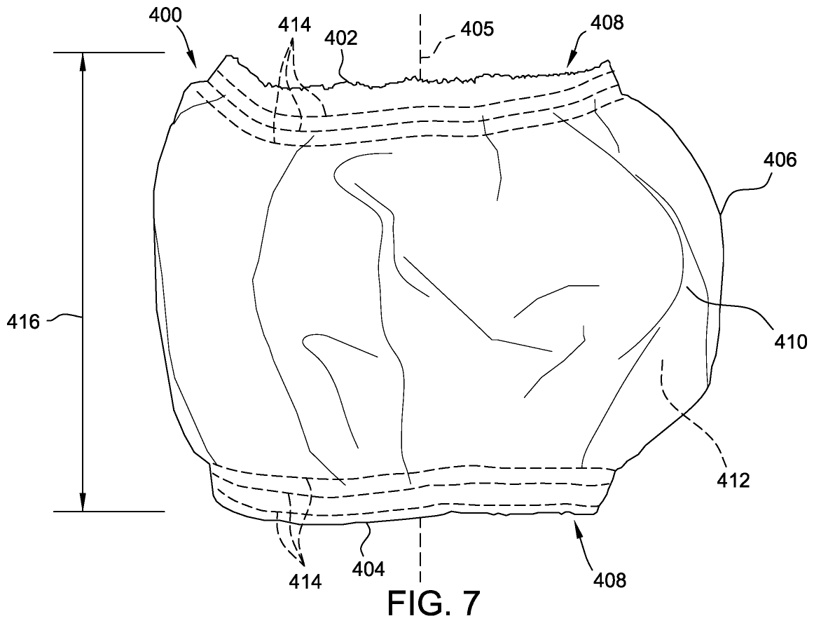

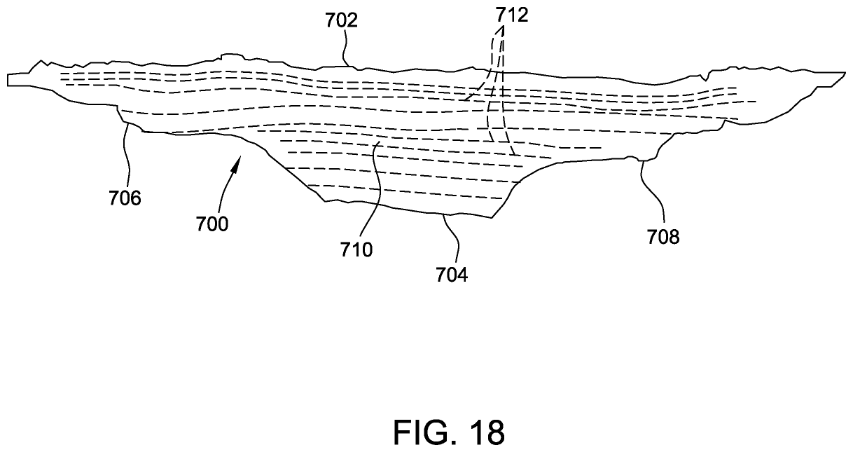

Referring still to FIG. 3, in the illustrated embodiment, the system 302 is adapted to produce face coverings 300 that have a ring or sleeve shape, similar to the face covering 400 shown in FIGS. 6 and 7. In other embodiments, the system 302 may be used to produce any suitable face coverings. For example, in one suitable embodiment, the system 302 can be modified by adding a machine direction folder followed by a cross direction cut & sealer after the ultrasonic bonding apparatus 316. In this embodiment, the system 302 can be used to produce a face covering in the style of a bandana (see, e.g., FIG. 18).

The face coverings 300 produced using the system 302 can be any suitable shape and size. Suitably, in some embodiments, a face covering 300 may have a length of 24 in. measured along the extension of the elastic strands of the elastic nonwoven fabric when the face covering is fully elongated. In some embodiments, the face coverings 300 may have a circumference in a range of about 8 in. to about 50 in. and a width defined between the edges in a range of about 3 in. to about 16 in. In other embodiments, the face coverings 300 may be any suitable size.

In some embodiments, the face coverings 300 may include one or more colors or visual ornamentation that are selected for aesthetic appeal or to convey information to people. For example, the interior and exterior surfaces of the face coverings 300 may be different colors to help indicate to a wearer how the face coverings should be worn. In addition, the front and back or the top and bottom of the face coverings 300 may be different colors to indicate the orientation of the face covering. Also, elastic strands of the face coverings 300 may be color coded to indicate an orientation of the face coverings and/or to indicate an interior or exterior of the face coverings. In addition, the face coverings 300 may include colors or visual markings that indicate directions for wearing the face coverings, distinguish a category of protection level of the face covering, or indicate a position, rank, or duty of the wearer.

FIGS. 6 and 7 illustrate a face covering 400 fabricated using the system 100 (shown in FIG. 1) and the system 302 (shown in FIG. 3). Suitably, the face covering 400 seen in FIGS. 6 and 7 is manufactured using ultrasonic bonding and is free of any adhesives. The face covering 400 has a first edge 402, a second edge 404, and a nonwoven body 406 extending between the first edge and the second edge.

The first edge 402 and the second edge 404 form a perimeter of the face covering 400 and each define an opening 408. The edges 402, 404 are generally parallel to each other (i.e., the first edge 402 and the second edge 404 do not intersect each other). The face covering 400 illustrated in FIGS. 6 and 7 does not include any edges other than the edges 402, 404. Accordingly, the face covering 400 may provide a better seal and be easier to don properly than some face coverings that have multiple edges extending in different directions.

The nonwoven body 406 extends continuously between the first edge 402 and the second edge 404 and around an axis 405 extending through the openings 408. Accordingly, in this illustrated embodiment, the face covering 400 is a sleeve (or ring). Suitably, the interior of the face covering 400 is less likely to be exposed to contaminants because the interior is on the inside of the sleeve. In alternative embodiments, the face covering 400 may be any suitable shapes.

The nonwoven body 406 includes an outer first layer 410 and an inner second layer 412. The first layer 410 and the second layer 412 are constructed to allow airflow through the face covering and to filter at least some particulates in the airflow. The nonwoven body 406 may include any suitable filter materials. For example, the first layer 410 and/or the second layer 412 may include a filter material such as a nonwoven polypropylene spunbond-meltblown-spunbond (SMS) material. In some embodiments, a separate filter material may be included between the layers. Suitably, the filter material extends throughout the entire nonwoven body 406 such that the entire nonwoven body 406 acts as a filter.

The face covering 400 may be worn such that one of the edges 402, 404 of the face covering is sealed against the neck of the wearer and the other edge is sealed above the mouth and at least part of the nose (e.g., nostrils) of the wearer. Accordingly, the face covering 400 may reduce interference with jaw movement or enunciation and ensure the seals are not compromised by jaw movement or a hairline of the wearer. In alternative embodiments, the face covering 400 may be configured to cover substantially the entire head of the wearer similar to a hood. In some embodiments, the face covering 400 may include openings for the eyes and ears.

In addition, the edges 402, 404 each include at least one elastic strand or element 414. Accordingly, in this illustrated embodiment, the edges 402, 404 form elastic bands (or a plurality of elastic strands 414) that seal against a wearer. For example, the strands 414 may be entrapped between the layers 410, 412 in an intermittent bonding process. In other embodiments, the edges 402, 404 may be folded over and bonded to seal the strands 414 therein. In some embodiments, the face covering 400 may include elastic strands throughout the nonwoven body 406 in addition to the elastic strands 414 at the edges 402, 404 such that the face covering is fully elastic.

The elastic strands 414 may be any suitable material. For example, in some embodiments, the elastic strands 414 include elastane and are free of latex. Suitably, the elastic strands 414 allow the face covering 400 to conform to the contours of the face and neck of the wearer. In addition, the elastic strands 414 support the face covering in position without ties, ear loops, or other securement mechanisms.

The face covering 400 may include any number of the elastic strands 414. For example, the face covering 400 may include four elastic strands 414 at each edge 402, 404. Each elastic strand may have a linear density of approximately 800 decitex. In an alternative embodiment, the face covering 400 may include four to six strands positioned in the nonwoven body 406 between the edges 402, 404. The elastic strands 414 positioned between the edges 402, 404 may have a density of 540 decitex or less.

The first edge 402 and the second edge 404 may be any suitable shape and size. In the illustrated embodiment, the first edge 402 and the second edge 404 are circles when the face covering 400 is in an untensioned or relaxed state. Suitably, the elastic strands 414 extend along the edges 402, 404 and circumscribe the openings 408 such that the openings have a circumference that is less than a circumference of the first and second layers 410, 412 when the face covering 400 is in a relaxed state. The edges 402, 404 may have a circumference in a range of about 0.1 in. to about 100 in. or about 8 in. to about 50 in. The shape, size, and elasticity of the edges 402, 404 enables the face covering 400 to fit different people. In this illustrated embodiment, the first edge 402 and the second edge 404 are the same shape and size. Accordingly, the face covering 400 is symmetric and may be worn in different orientations. For example, the first edge 402 and the second edge 404 are sized to seal against the face or neck of the wearer. In alternative embodiments, the first edge 402 and the second edge 404 may be different sizes or shapes. For example, in some embodiments, the first edge 402 is sized to seal around the face of a wearer and the second edge 404 is smaller than the first edge 402 and is sized to seal around the neck of the wearer.

In this illustrated embodiment, the face covering 400 does not include any openings other than the openings 408 defined by the first edge 402 and the second edge 404. Accordingly, when the first edge 402 and the second edge 404 are sealed against the wearer, airflow only moves between the interior and exterior of the face covering 400 through the nonwoven body 406. As a result, the airflow is filtered and particulates are removed from the airflow by the nonwoven body 406.

The nonwoven body 406 may be any suitable size and shape. For example, in some embodiments, the nonwoven body 406 has a width 416 defined between the edges 402, 404. The width 416 may be in a range of about 0.1 in. to about 100 in. or about 3 in. to about 16 in. The width 416 enables the face covering 400 to cover a desired portion of the wearer's face. For example, the face covering 400 may be sized to extend from the neck of the wearer to above the nose or the nostrils of the wearer. In addition, the nonwoven body 406 may provide a filtration surface area that is at least 75 square in. Accordingly, the face covering 400 may provide a decreased pressure differential across the filtration surface area to allow the nonwoven body 406 to more effectively filter the air.

The face covering 400 is arranged such that the edges 402, 404 provide a tight seal against the wearer and the nonwoven body 406 provides a loose fit to increase comfort of the face covering and provide increased filtration of the airflow through the face covering. Suitably, the nonwoven body 406 is sized such that the surface area of the nonwoven body is greater than the perimeter defined by the edges 402, 404. For example, a ratio of the perimeter defined by the edges 402, 404 to a filtration area of the nonwoven body 406 is equal to or less than approximately 0.35. The filtration area is the portion of the face covering 400 that filters airflow. For example, in suitable embodiments, the filtration area is the entire area of the nonwoven body 406 that is not sealed against the wearer and is available to filter airflow. In this illustrated embodiment, the filtration area is the area of the nonwoven body 406 that is free of the elastic strands 414.

In some embodiments, a ratio of the perimeter to the filtration area of the face covering 400 is in a range of about 0.11 to about 0.28. The ratio of perimeter to filtration area of the face covering 400 provides a lower effective pressure differential than conventional face masks or coverings and increases the ability of the nonwoven body 406 to filter airflow. In addition, the face covering 400 has a reduced leakage through any seams in the face covering because of the lower pressure differential.

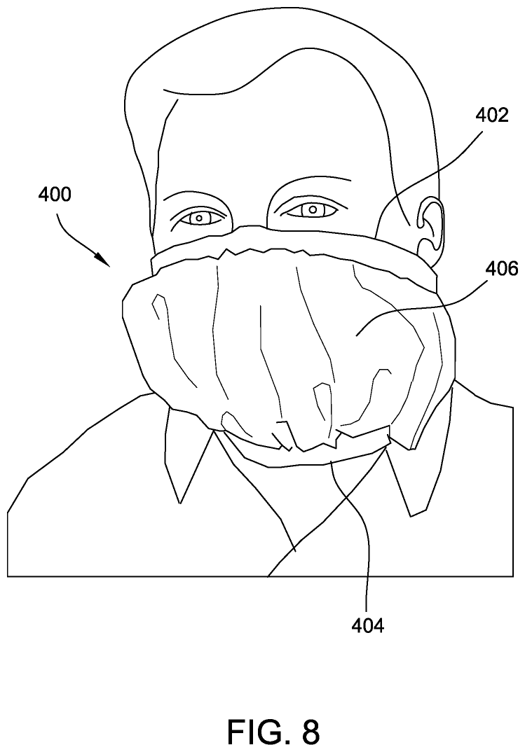

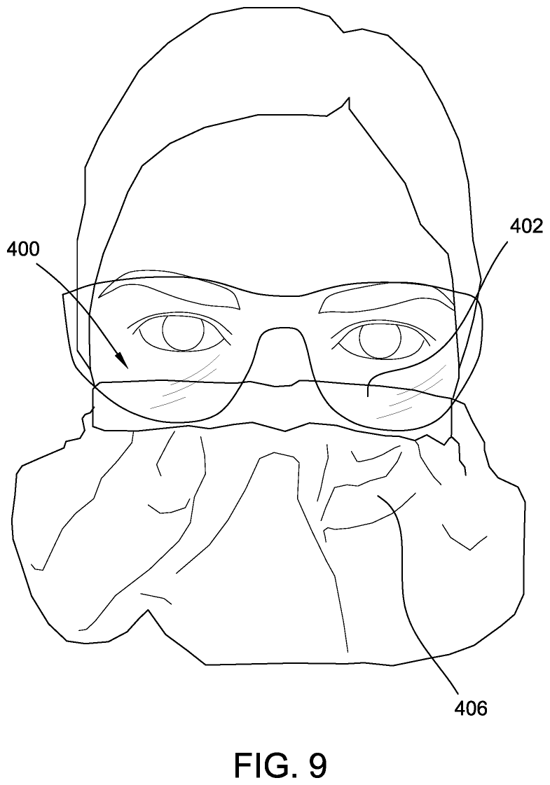

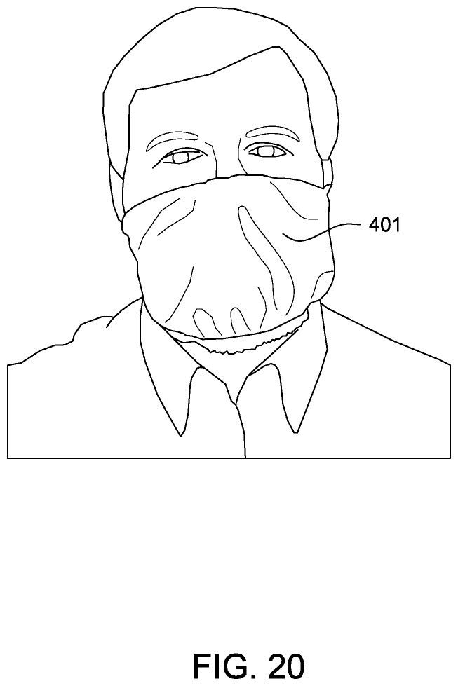

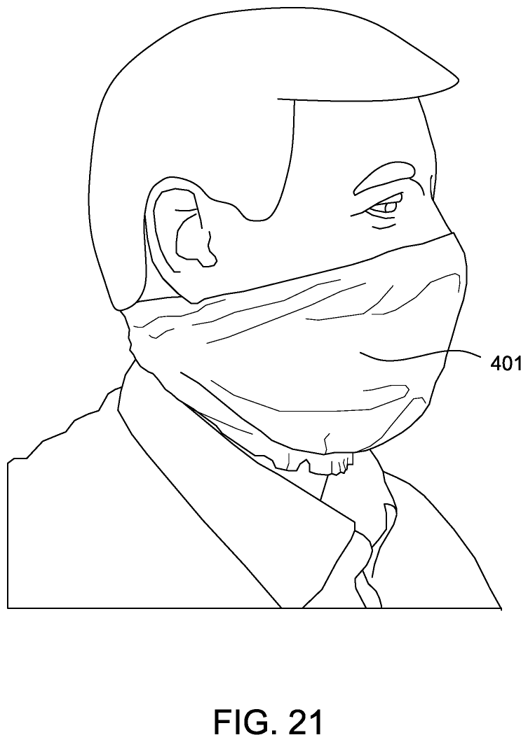

As seen in FIGS. 8-12, the face covering 400 is sized and shaped to fit people with different profiles and hairlines. In this illustrated embodiment, the face covering 400 provides a loose fit (i.e., the face covering is not stretched taunt or pressed against the wearer's face when worn) and is configured to extend around the circumference of the wearer's head. In embodiments such as the embodiment shown in FIGS. 20 and 21, the face covering 401 may have a slightly greater ratio of the perimeter to filtration area such that the nonwoven body is smaller and provides a relatively tight fit against the face of the wearer. The face covering 400 may be worn such that the face covering extends from the neck to above the nose of the wearer. Suitably, the face covering 400 can be provided as a one-size-fits-all option or provided in a limited number of sizes. Sometimes, the face covering 400 may be partly rolled up at one or both of the edges 402, 404 to remove some slack in the nonwoven body 406 or to fit a smaller person (e.g., a child).

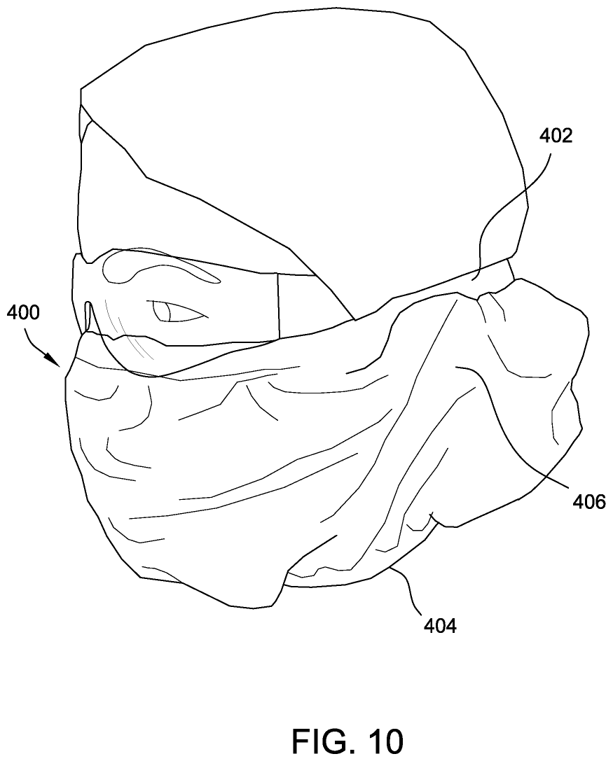

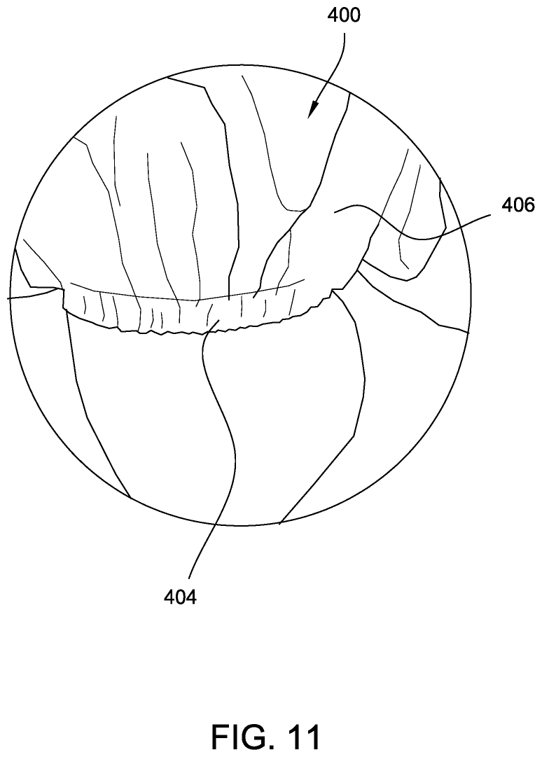

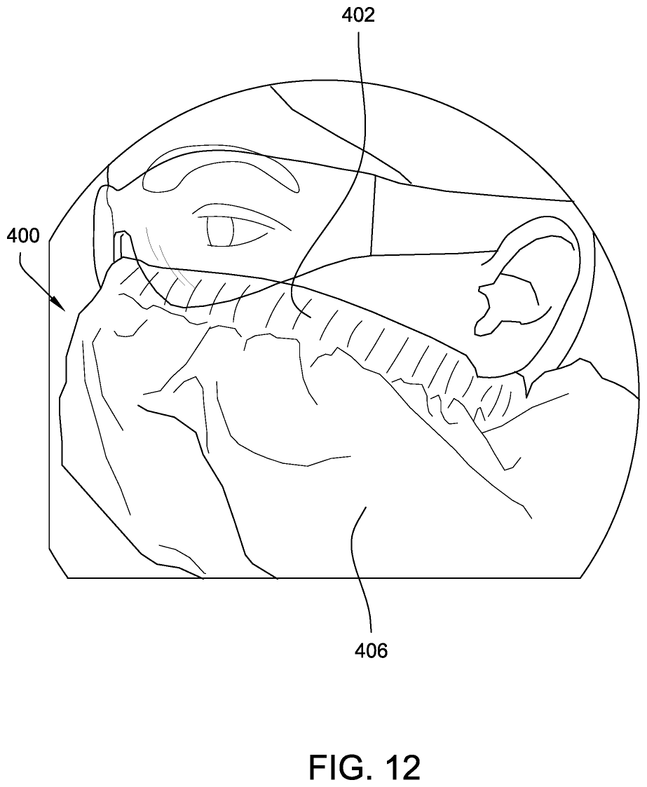

Suitably, the position of the face covering 400 may be adjusted by the wearer to provide more comfort or provide a desired level of protection. For example, as seen in FIG. 8, the face covering 400 may be worn with the ears uncovered. Alternatively, as seen in FIG. 10, the face covering 400 may be worn over the ears to protect the ear canals from contaminants and provide additional support for the face covering. In addition, the face covering 400 may be worn over or under the hair of the wearer and may be worn with glasses (FIG. 12) or without glasses (FIG. 8). A lower edge 402, 404 of the face covering 400 may be sealed against the face below the mouth of the wearer or against the neck of the wearer as shown in FIG. 11.

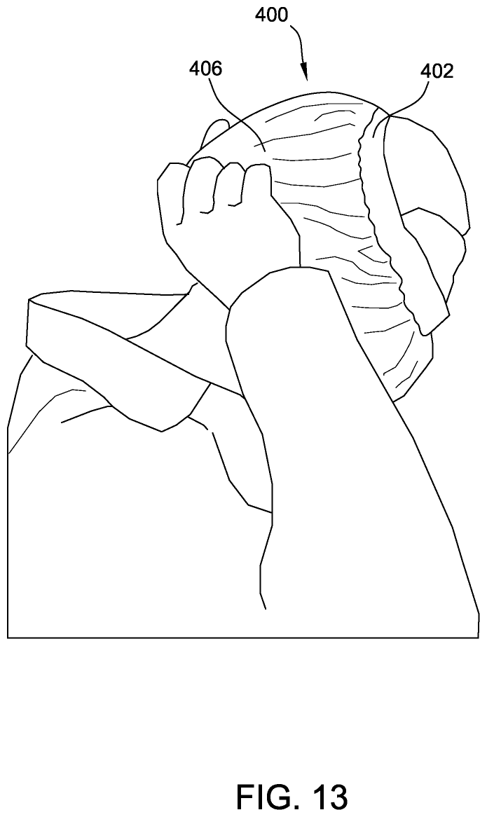

FIG. 13 illustrates a person donning the face covering 400 by pulling it onto their head. To put on or don the face covering 400, the face covering 400 may be opened by stretching the elastic strands 414 at the edges 402, 404 to separate the ruffles on the edges and, thus, widen the openings 408 for receiving the head. When the face covering 400 is in the opened position, the face covering 400 may be positioned onto the head of the wearer with the edges 402, 404 positioned around the crown of the head. Then, the lower edge 402, 404 may be pulled downward to the neck of the wearer. The upper edge 402, 404 may be adjusted to a comfortable position above the mouth and/or nostrils of the wearer. Suitably, the face covering 400 is symmetric such that either edge 402, 404 can be the upper or lower edge.

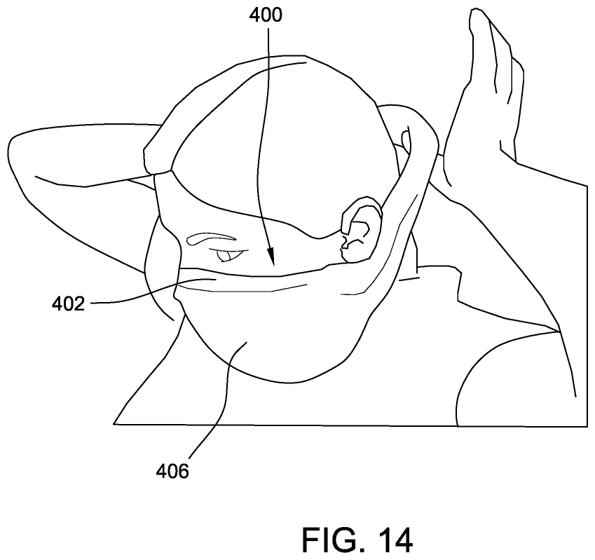

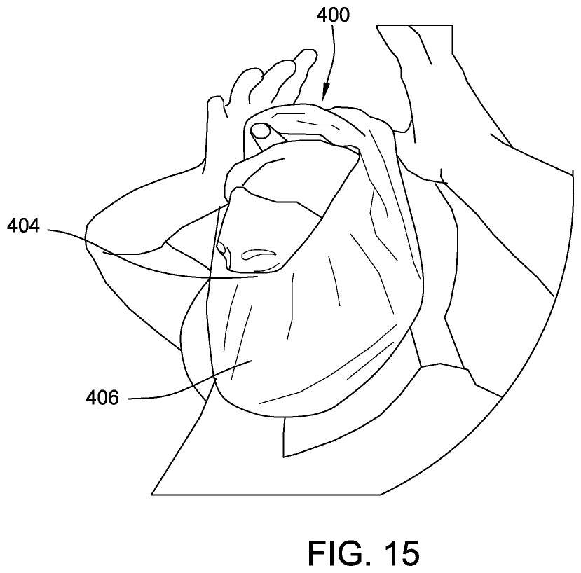

Referring to FIGS. 14 and 15, the face covering 400 can be quickly and easily manually removed after use. For example, the wearer or another person assisting the wearer may grasp the inside of the lower edge and gather the nonwoven body at the back of the head. The person may only contact the interior of the face covering to reduce exposure to potential contaminates on the exterior of the face covering. The person may pull the face covering 400 upward over the head and turn the face covering inside out as the face covering is pulled over the head. The face covering 400 may be disposed of after use or sanitized for reuse. Thus, the face covering 400 may be disposable or reusable. In some embodiments, the face covering 400 may include a tear line or a line of separation adapted to allow for removal of the face covering by tearing the face covering.

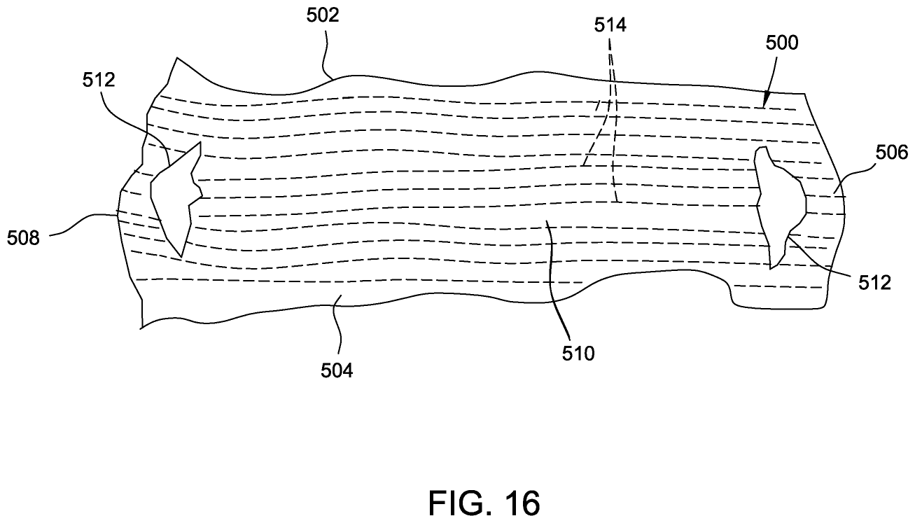

FIG. 16 illustrates a face covering 500 that can be fabricated using the system 100 (shown in FIG. 1) and/or the system 302 (shown in FIG. 3). The face covering 500 of this embodiment has a first edge 502, a second edge 504, a third edge 506, a fourth edge 508, and a nonwoven body 510. The first edge 502 and the second edge 504 extend along a length of the face covering 500 and the third edge 506 and the fourth edge 508 extend perpendicular to the first edge and the second edge.

The nonwoven body 510 may be any suitable shape and size. In this illustrated embodiment, the nonwoven body 510 is a rectangle and is sized to extend from one ear to another ear and across the mouth and nose of the wearer. The nonwoven body 510 defines openings 512 near the third edge 506 and the fourth edge 508 that are shaped to receive the ears of the wearer and support the face covering.

The face covering 500 also includes a plurality of elastic strands 514 extending parallel to the first edge 502 and the second edge 504 and between the third edge 506 and the fourth edge 508. The elastic strands 514 are spaced throughout the nonwoven body 510 such that the face covering 500 is fully elastic, i.e., the entire face covering stretches and retracts.

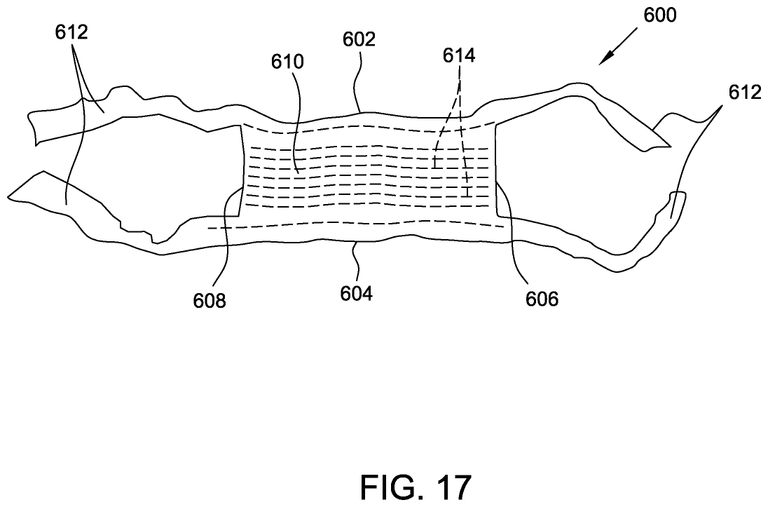

FIG. 17 illustrates a face covering 600 that can be fabricated using the system 100 (shown in FIG. 1) and/or the system 302 (shown in FIG. 3). The face covering 600 of this embodiment has a first edge 602, a second edge 604, a third edge 606, a fourth edge 608, a nonwoven body 610, and ties 612. The first edge 602 and the second edge 604 extend along a length of the face covering 600 and the third edge 606 and the fourth edge 608 extend perpendicular to the first edge and the second edge.

The nonwoven body 610 may be any suitable shape and size. In this illustrated embodiment, the nonwoven body 610 is a rectangle and is sized to extend from one ear to the other ear across the mouth and nose of the wearer.

The ties 612 extend from the third edge 606 and the fourth edge 608 and are sized to extend around the back of the head of the wearer to support the face covering 600. In this illustrated embodiment, the face covering 600 includes two pairs of ties 612. In other embodiments, the face covering 600 may include any suitable number of ties 612.

The face covering 600 also includes a plurality of elastic strands 614 extending parallel to the first edge 602 and the second edge 604. The elastic strands 614 extend throughout the nonwoven body 610 and the ties 612 such that the face covering 600 is fully elastic, i.e., the entire face covering stretches and retracts. As noted, the ties 612 are fully elastic in this embodiment. It is contemplated that in some suitable embodiments, the ties are non-elastic.

FIG. 18 illustrates a face covering 700 that can be fabricated using the system 100 (shown in FIG. 1) and/or the system 302 (shown in FIG. 3). The face covering 700 has a first edge 702, a second edge 704, a third edge 706, a fourth edge 708, and a nonwoven body 710. The first edge 702 and the second edge 704 extend along a length of the face covering 700. The third edge 706 and the fourth edge 708 extend at an angle relative to the first edge 702 and the second edge 704.

The nonwoven body 710 may be any suitable shape and size. In this illustrated embodiment, the nonwoven body 710 is generally triangular and is sized to extend around the entire circumference of the wearer's head such that the face covering 700 extends across the mouth and nose of the wearer and behind the head of the wearer. Corners of the nonwoven body 710 can be tied behind the head of the wearer to support the face covering 700.

The face covering 700 also includes a plurality of elastic strands 712 extending parallel to the first edge 702 and the second edge 704. The elastic strands 712 extend throughout the nonwoven body 710 such that the face covering 700 is fully elastic, i.e., the entire face covering stretches and retracts.

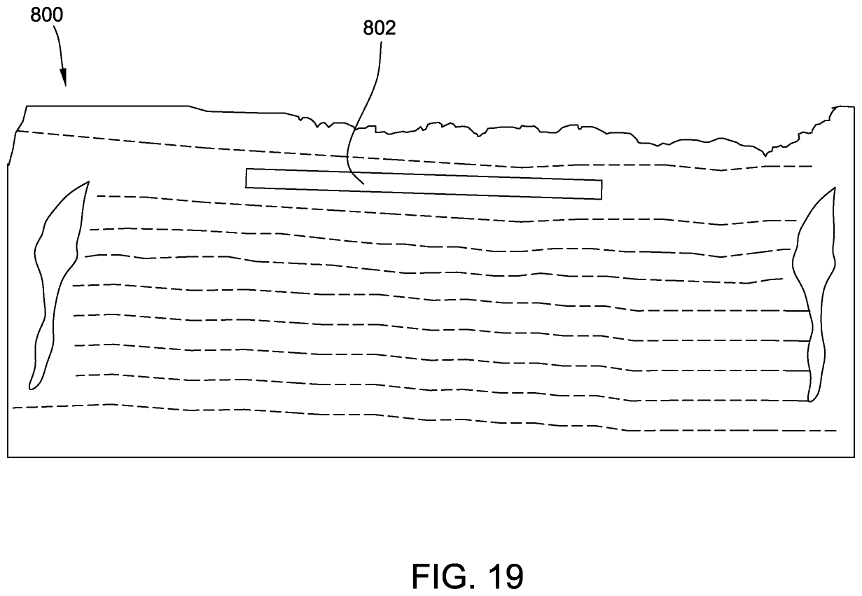

FIG. 19 illustrates a face covering 800 that can fabricated using the system 100 (shown in FIG. 1) and/or the system 302 (shown in FIG. 3). The face covering 800 is similar to the face covering 500 (shown in FIG. 16) except the face covering 800 includes a nose piece 802. The nose piece 802 includes a flexible, semi-rigid material (i.e., a material that can be bent when a force is applied to it but maintains a defined shape when at rest) such as a thin piece of metal that is sized and shaped to fit over the nose of the wearer. The nose piece 802 may bent over the nose to provide an improved seal of the face covering 800 around the nose.

Suitably, the face coverings (e.g., face coverings 300, 400, 500, 600, 700, 800) of the present disclosure have a Mean Particle Removal Efficiency (%) greater than 75% and more suitably greater than 80%. For example, the face covering 400 (shown in FIGS. 6-8) has a Mean Particle Removal Efficiency (%) of approximately 87%. The face covering 401 (shown in FIGS. 20 and 21) has a Mean Particle Removal Efficiency (%) of approximately 82%.

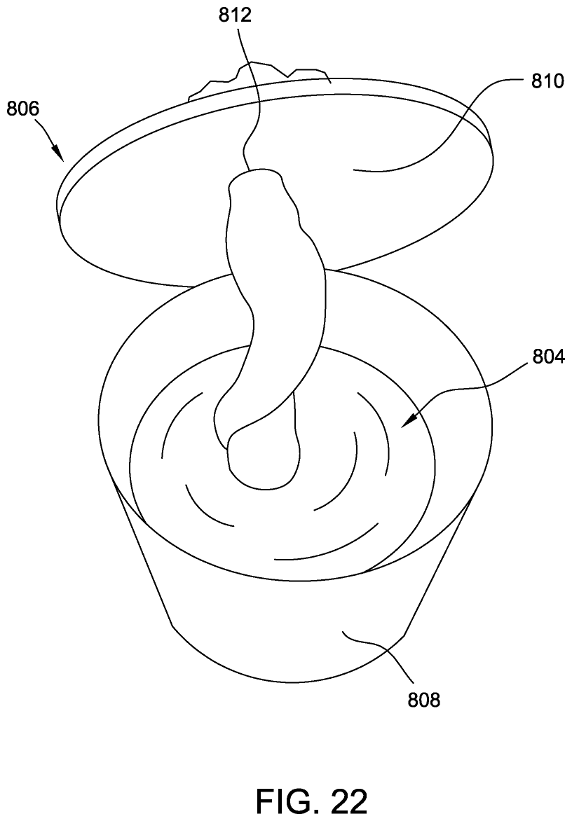

FIG. 22 shows a roll 804 of face coverings (e.g., face coverings 300, 400, 500, 600, 700, 800) that are positioned in a container 806. The container 806 is a cylinder and is sized and shaped to receive the roll 804. The container 806 allows the face coverings to be packaged for storage as a connected continuous unit (e.g., a roll) and enables efficient dispensing of the face coverings. For example, the container 806 may be adapted to contain at least 100 of the face coverings. Accordingly, the container 806 reduces the amount of packaging that is required per face covering. In addition, the container 806 may enable bulk quantities of the face coverings to be processed and shipped in a reduced time period in comparison to face coverings that are packaged individually.

The container 806, as seen in FIG. 22, includes a bucket 808 and a lid 810. The lid 810 defines an opening 812 for dispensing the face coverings. The container 806 can be made from any suitable material including, but not limited to, cardboard, plastic, metal, or combinations thereof (e.g., the bucket 808 can be made of plastic or metal and the lid 810 can be made of cardboard).

The container 806 may be configured to automatically separate face coverings when a single face covering is dispensed from the container 806. For example, the lid 810 may include a notch or protuberance that acts a catch and retains a subsequent face covering when a face covering is removed from the container 806 through the opening 812. The notch or protuberance may cause the face coverings to separate when the single face covering is removed such that the person only needs to touch the face covering being dispensed. The face coverings may be separated along seams formed during the bonding process.

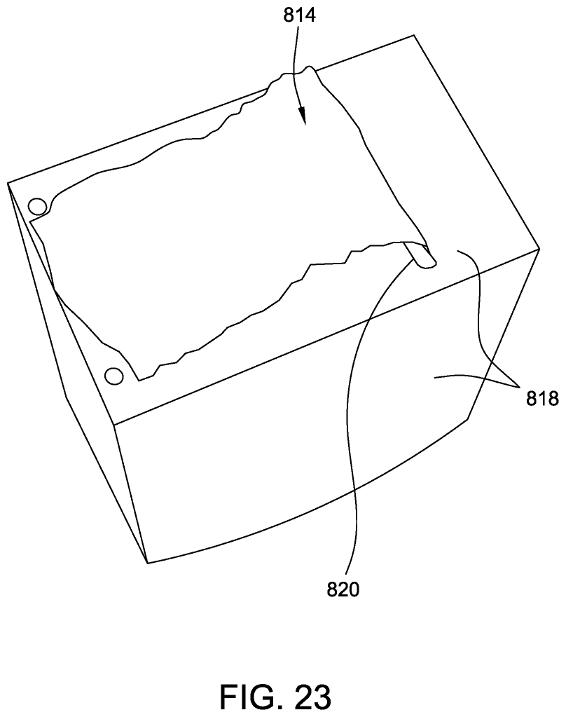

FIG. 23 shows a stack 814 of face coverings that are positioned in a container 816. The container 816 is a rectangular cuboid and includes six walls 818. At least one of the walls 818 defines a slot 820 for dispensing the face coverings. The container 806 allows the face coverings to be packaged for storage as a connected continuous unit (e.g., folded or unfolded arrangements) and enables efficient dispensing of the face coverings. The container 816 may utilize standard dimensions and be sized and shaped to increase the number of units that fit in a space.

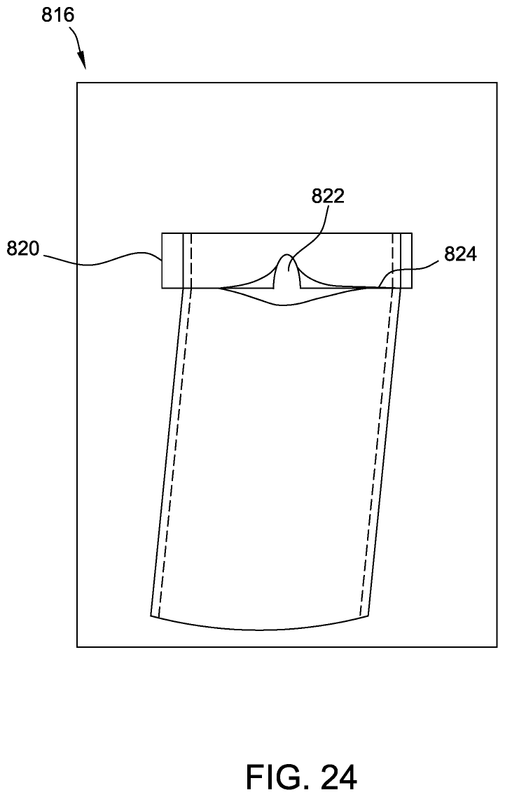

Referring to FIG. 24, the container 816 may be configured to automatically separate the face coverings when a single face covering is dispensed from the container. For example, the container 816 may include a notch or protuberance that acts a catch 822 and retains a subsequent face covering when a face covering is removed from the container through the opening 812. In the illustrated embodiment, the catch 822 extends from a perimeter of the slot 820 at least midway across the width of the slot. The catch 822 may cause the face coverings to separate along lines of separation 824 when the single face covering is removed such that the person only needs to touch the face covering being dispensed. The lines of separation 824 may be formed during the bonding process. For example, the lines of separations 824 may extend along seams formed when non-woven materials are bonded together during fabrication of the face coverings.

It is contemplated that the face coverings can be packaged in other types of suitable packaging without departing from some aspects of this disclosure. For example, the container 816 can comprise at least one closure in at least one of the walls 818 such that the container can be opened from at least one of the sides of the container.

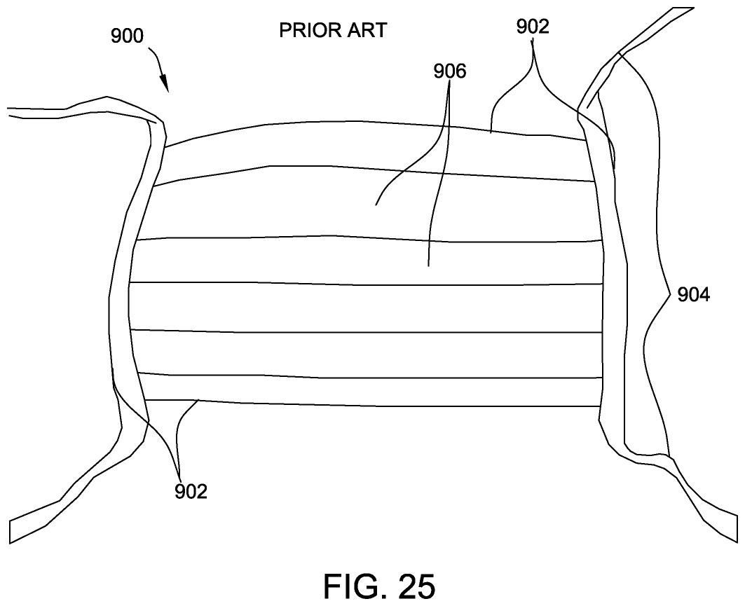

FIG. 25 shows a prior art face mask 900. The face mask 900 includes edges 902 defining a perimeter of the mask 900 and surrounding a rectangular filtration area of the face mask. Embodiments of the face coverings described herein (e.g., face coverings 300, 400, 500, 600, 700, 800) provide several advantages over the prior art face mask 900. For example, referring to FIGS. 7 and 25, the face covering 400 has a filtration area that is at least 5 times greater than the filtration area of the face mask 900. Moreover, the face covering 400 has a lower perimeter to filtration area ratio than the prior art face mask 900. As a result, the face covering 400 has a lower pressure differential and may provide more effective filtration of the air than the prior art face mask 900.

In addition, the face mask 900 includes ties 904 and pleats 906 which may make the face mask 900 more difficult to don and less effective at filtering than the face covering 400. For example, to don the face mask 900, a person must position the ties behind the head and tie the ties tightly together to provide a proper seal. In addition, the wearer must ensure that the face mask 900 is in the proper orientation and that the pleats 906 face the proper direction for the face mask to filter air properly. If donned incorrectly, the face mask 900 may not function properly. Moreover, the face mask 900 may not remain in position during use even if the person initially dons the face mask 900 properly. For example, the ties may become loose or sag during use. In contrast, the face covering 400 does not require any ties to secure to the head and the elastic strands ensure that the face covering 400 remains sealed and in position during use.

The methods for producing face coverings and the face coverings described and shown herein provide face coverings that are less expensive to produce than conventional face coverings. In addition, the face coverings are easy to don properly and help reduce the transmission of viruses through the air when people are socially interacting. Embodiments of the face coverings may provide a loose fit on the wearer to increase the efficacy of the air filtration of the face coverings and provide comfort for the wearer. In addition, the face coverings may include elasticized portions which seal against the wearer and supports the face covering in a proper position. The face coverings accommodate different profiles, hairlines, and other features of wearers.

In addition, the methods for producing face coverings and the face coverings described and shown herein may be produced using a continuous manufacturing process and may be packaged for bulk shipment. The face coverings may be dispensed from a container and automatically separated to reduce the risk of contamination of the face coverings.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the disclosure, it is intended that all matter contained in the above description or shown in the accompanying drawings shall be interpreted as illustrative and not in a limiting sense.

What is claimed is:

1. A face covering comprising:
a first layer of nonwoven material;
a second layer of nonwoven material, the first layer of nonwoven material and the second layer of nonwoven material cooperatively defining a first opening, a second opening, and a filtration area of the face covering, the filtration area being arranged to allow airflow through the face covering and remove particulates from the airflow, the first opening and the second opening being sized to receive a head of a wearer;
a first elastic element secured to the first and second layers; and
a second elastic element secured to the first and second layers, the face covering being sized such that, when the face covering is positioned on the head of the wearer, the first and second elastic elements provide a seal against the wearer and the first and second layers provide a loose fit on the wearer, a ratio of a perimeter of the face covering to the filtration area being equal to or less than 0.35.

2. A face covering of claim 1, wherein the first and second layers cooperatively define a first edge and a second edge, the first edge and the second edge being parallel to each other.

3. A face covering of claim 1, wherein at least one of the first opening and the second opening is a circle having a circumference in a range of about 8 in. to about 50 in. when the face covering is in a relaxed state.

4. A face covering of claim 3, wherein the first and second layers have a width in a range of about 3 in. to about 16 in.

5. A face covering of claim 1, wherein the first and second layers form a sleeve that extends continuously between the first opening and the second opening and along an axis.

6. A face covering of claim 1, wherein the face covering does not have any openings other than the first opening and the second opening.

7. A face covering of claim 1, wherein the face covering is produced in a continuous form using a continuous manufacturing method, the face covering being connected to at least one other face covering.

8. A face covering of claim 7, wherein the connected face coverings are arranged to form one of a roll, a folded stack, and an unfolded pile.

9. A face covering of claim 7, wherein the face covering is connected to the at least one other face covering along a seam extending perpendicular to the first and second elastic elements, and wherein the face coverings are configured to separate from each other along the seam.

10. A face covering comprising:
layers of nonwoven material cooperatively defining a first opening and a second opening, the layers of nonwoven material forming a sleeve that extends continuously between the first opening and the second opening, the first and second openings each being circular and having a circumference when the face covering is in a relaxed state;
a first elastic element secured to the layers of nonwoven material and circumscribing the first opening such that the circumference of the first opening is less than a circumference of the sleeve between the first and second openings when the face covering is in the relaxed state; and
a second elastic element secured to the layers of nonwoven material and circumscribing the second opening such that the circumference of the second opening is less than the circumference of the sleeve between the first and second openings when the face covering is in the relaxed state, the face covering being sized such that, when the face covering is positioned on a head of a wearer, the first and second elastic elements provide a seal against the wearer and the layers of nonwoven material provide a loose fit on the wearer.

11. A face covering of claim 10, wherein the first elastic element and the second elastic element are substantially parallel to each other.

12. A face covering of claim 10, wherein at least one of the first opening and the second opening has a circumference in a range of about 8 in. to about 50 in. when the face covering is in the relaxed state.

13. A face covering of claim 12, wherein the layers of nonwoven material have a width in a range of about 3 in. to about 16 in.

14. A face covering of claim 10, wherein the face covering does not have any openings other than the first opening and the second opening.

15. A face covering of claim 10, wherein the layers of nonwoven material cooperatively define a filtration area of the face covering, the filtration area being arranged to allow airflow through the face covering and remove particulates from the airflow, a ratio of a perimeter of the face covering to the filtration area being equal to or less than 0.35.

16. A package of nonwoven face coverings, the package including:
face coverings each comprising:
a first layer of nonwoven material;
a second layer of nonwoven material, the first layer of nonwoven material and the second layer of nonwoven material cooperatively defining a first opening, a second opening, and a filtration area of the face covering, the filtration area being arranged to allow airflow through the face covering and remove particulates from the airflow, the first opening and the second opening being sized to receive a head of a wearer;
a first elastic element secured to the first and second layers; and
a second elastic element secured to the first and second layers, wherein each face covering is sized such that the first and second elastic elements provide a seal against a wearer and the first and second nonwoven layers provide a loose fit on the wearer, a ratio of a perimeter of the face covering to the filtration area being equal to or less than 0.35, wherein the face coverings are produced in a continuous form using a continuous manufacturing method and are connected to each other; and
a container to hold the face coverings, the container including an opening for dispensing the face coverings, wherein the container is configured to separate a single face covering from the other face coverings when a person removes the single face covering from the container through the opening.

17. A package of claim 16, wherein the face coverings are arranged to form one of a roll, a folded stack, and an unfolded pile.

18. (canceled)

19. A package of claim 16, wherein the face coverings are connected to each other along seams extending perpendicular to the first and second elastic elements, and wherein the face coverings are configured to separate from each other along the seams.

20. A package of claim 16, wherein the container includes a catch at the opening, the catch arranged to retain the other face coverings when the person removes the single face covering from the container through the opening.
